(19) United States
(12) Patent Application Publication
(10) Pub. No.: US 2026/0236071 A1
(43) Pub. Date: Aug. 13, 2026

(54) LAPTOP COMPUTER

(71) Applicant: Quanta Computer Inc., Taoyuan City (TW)

(72) Inventors: Hui LIN, Taoyuan City (TW); Chen-An LU, Taoyuan City (TW)

(21) Appl. No.: 19/092,272

(22) Filed: Mar. 27, 2025

(30) Foreign Application Priority Data
Feb. 13, 2025 (TW) 114105334

(51) Int. Cl. G06F 1/16

(52) U.S. Cl. CPC G06F 1/1698; G06F 1/1616; G06F 1/1683

(57) ABSTRACT

A laptop computer is provided. The laptop computer includes a computer body, a cover, an antenna bracket and an antenna module. The computer body includes a first hinge unit and a second hinge unit. The cover is rotatably connected to the computer body via the first hinge unit. The antenna bracket is rotatably connected to the computer body via the second hinge unit. The antenna module is disposed on the antenna bracket and configured to transmit a wireless signal.

### CROSS REFERENCE TO RELATED APPLICATIONS

This Application claims priority of Taiwan Patent Application No. 114105334, filed on Feb. 13, 2025, the entirety of which is incorporated by reference herein.

### BACKGROUND OF THE INVENTION

### Field of the Invention

The present invention relates to a laptop computer, and, in particular, it relates to laptop computer with an antenna bracket.

### Description of the Related Art

Currently, conventional laptops do not have built-in satellite communication capabilities. If a user is in a remote area without cellular base stations or wired networks, the laptop itself cannot provide internet connectivity. Conventionally, a laptop must rely on an external satellite communication device to enable network access. However, satellite communication devices are typically bulky and require multiple cables, adapters, and access points (APs) for connection, making them inconvenient to carry and use. Therefore, there is a need for a laptop with integrated satellite communication functionality.

### BRIEF SUMMARY OF THE INVENTION

In one embodiment, a laptop computer is provided. The laptop computer includes a computer body, a cover, an antenna bracket and an antenna module. The computer body includes a first hinge unit and a second hinge unit. The cover is rotatably connected to the computer body via the first hinge unit. The antenna bracket is rotatably connected to the computer body via the second hinge unit. The antenna module is disposed on the antenna bracket and configured to transmit a wireless signal.

In one embodiment, the computer body comprises a body lateral side, the first hinge unit is disposed on the body lateral side, and the second hinge unit is also disposed on the body lateral side.

In one embodiment, the computer body comprises an input interface, a first surface, and a second surface. The first surface is opposite the second surface. The input interface is disposed on the first surface. The cover is configured to cover the first surface. The antenna bracket is configured to cover the second surface.

In one embodiment, in a first spatial posture, the antenna bracket is in a first bracket position and overlaps the computer body, and in a second spatial posture, the antenna bracket is in a second bracket position and forms a V-shaped structure with the computer body in a side projection plane.

In one embodiment, the cover comprises a screen and a phase modulation module, and the phase modulation module is opposite the screen.

In one embodiment, in a third spatial posture, the cover is in an open position relative to the computer body, the antenna bracket is in the second bracket position, and the phase modulation module is configured to perform phase modulation on at least a portion of the wireless signal.

In one embodiment, the cover comprises a screen and a lid, the screen is disposed on the lid, the lid comprises a non-metallic material, and the wireless signal is configured to pass through at least a portion of the cover for transmission.

In one embodiment, the antenna module comprises a feeding unit, a ground layer, a first patch unit and a second patch unit. The feeding unit includes a horizontal feeding conductor and a vertical feeding conductor. The ground layer corresponds to the feeding unit. The first patch unit corresponds to the feeding unit. The second patch unit corresponds to the feeding unit and the first patch unit, wherein the first patch unit is located between the second patch unit and the feeding unit.

In one embodiment, the horizontal feeding conductor comprises a first horizontal feeding structure and a second horizontal feeding structure, the vertical feeding conductor comprises a first vertical feeding structure and a second vertical feeding structure, the first horizontal feeding structure and the second horizontal feeding structure are arranged along a vertical line, and the first vertical feeding structure and the second vertical feeding structure are arranged along a horizontal line.

In one embodiment, at least a portion of the vertical feeding conductor is located between the first horizontal feeding structure and the second horizontal feeding structure.

In one embodiment, the first horizontal feeding structure and the second horizontal feeding structure are U-shaped, the first horizontal feeding structure comprises a first notch, the second horizontal feeding structure comprises a second notch, and the first notch faces the second notch.

In one embodiment, the first vertical feeding structure and the second vertical feeding structure are U-shaped. The first vertical feeding structure comprises a third notch. The second vertical feeding structure comprises a fourth notch. The third notch is opposite the fourth notch.

In one embodiment, the horizontal feeding conductor comprises an impedance matching structure. The impedance matching structure is connected to a connection point on the first horizontal feeding structure. The first surface current path is defined between the connection point and one end of the first horizontal feeding structure. The second surface current path is defined between the connection point and the other end of the first horizontal feeding structure. The length of the first surface current path is not equal to the length of the second surface current path.

In one embodiment, the first patch unit comprises four first patches. There is a plurality of feeding signals. The first horizontal feeding structure, the second horizontal feeding structure, the first vertical feeding structure, and the second vertical feeding structure each feeds a respective feeding signal to a corresponding first patch.

In one embodiment, the first patch unit comprises a plurality of capacitive coupling pads, which are not in direct contact with the first patches. The capacitive coupling pads are respectively coupled to the ends of the first horizontal feeding structure, the second horizontal feeding structure, the first vertical feeding structure, and the second vertical feeding structure.

In one embodiment, the second patch unit comprises four second patches, which are larger in size than the first patches. The second patches overlap the respective first patches.

In one embodiment, a gap is formed between each capacitive coupling pad and the adjacent first patch. The second patch covers the corresponding gaps.

In one embodiment, the ground layer is located between the feeding unit and the first patch unit.

In the laptop computer of the embodiment of the invention, the cover is rotatably connected to the computer body through the first hinge unit. The antenna bracket is rotatably connected to the computer body through the second hinge unit. The antenna module is disposed on the antenna bracket. Accordingly, the laptop computer can provide satellite communication functionality through the antenna module on the antenna bracket. Additionally, the orientation of the antenna bracket relative to the computer body can be adjusted to achieve optimal signal transmission. The laptop computer of the embodiment of the invention features a simple structure and is easy to carry, offering excellent convenience for users.

### BRIEF DESCRIPTION OF THE DRAWINGS

The present invention can be more fully understood by reading the subsequent detailed description and examples with references made to the accompanying drawings, wherein:

FIGS. 1A and 1B show a laptop computer of an embodiment of the invention, wherein the laptop computer is in a first spatial posture;

FIG. 2 shows the laptop computer of the embodiment of the invention, wherein the laptop computer is in a second spatial posture;

FIGS. 3A and 3B show the laptop computer of the embodiment of the invention, wherein the laptop computer is in a third spatial posture;

FIG. 3C shows a laptop computer of a modified embodiment of the invention;

FIG. 4 is an exploded view of the antenna module of the embodiment of the invention;

FIG. 5 shows the details of the feeding unit of the embodiment of the invention;

FIG. 6 is an assembled view of the antenna module of the embodiment of the invention; and

FIG. 7 shows the details of the capacitive coupling pad and the first patch of the embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

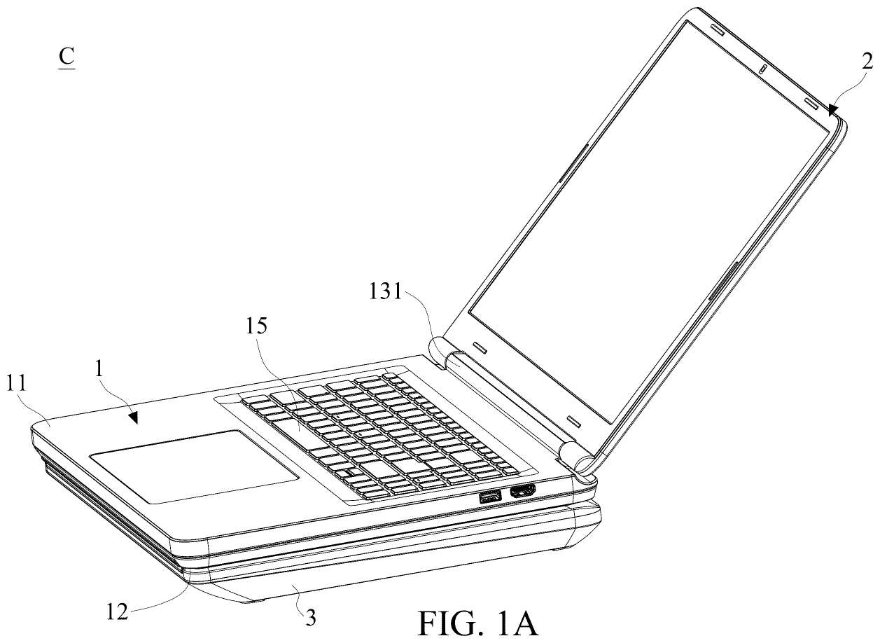

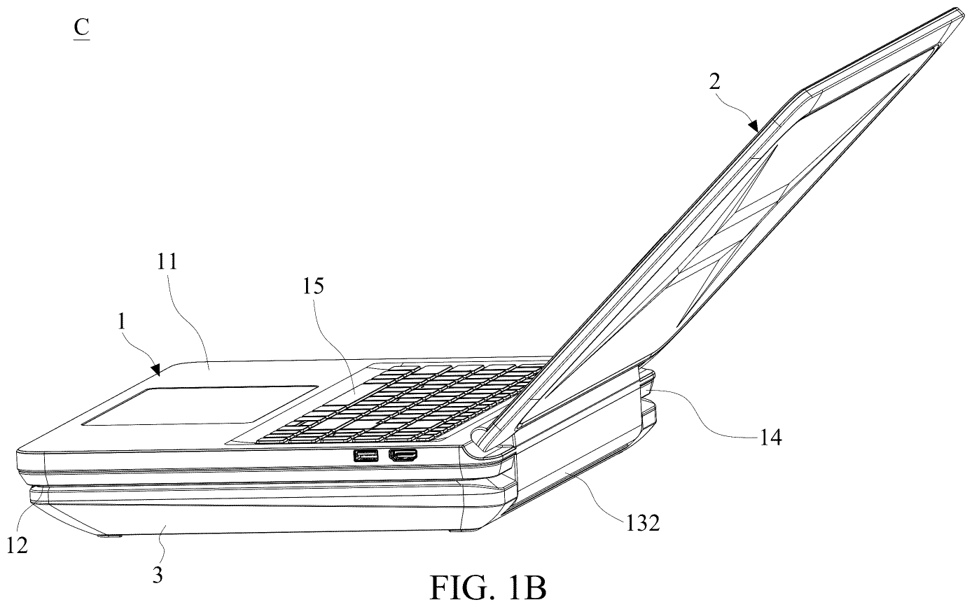

FIGS. 1A and 1B show a laptop computer of an embodiment of the invention, wherein the laptop computer is in a first spatial posture. With reference to FIGS. 1A and 1B, the laptop computer of the embodiment of the invention includes a computer body 1, a cover 2, an antenna bracket 3 and an antenna module (not shown). The computer body 1 includes a first hinge unit 131 and a second hinge unit 132. The cover 2 is rotatably connected to the computer body 1 via the first hinge unit 131. The antenna bracket 3 is rotatably connected to the computer body 1 via the second hinge unit 132. The antenna module (not shown) is disposed on the antenna bracket 3 and configured to transmit a wireless signal.

With reference to FIGS. 1A and 1B, in one embodiment, the computer body 1 comprises a body lateral side 14. The first hinge unit 131 is disposed on the body lateral side 14, and the second hinge unit 132 is also disposed on the body lateral side 14. In this embodiment, the body lateral side 14 is a straight side.

With reference to FIGS. 1A and 1B, in one embodiment, the computer body 1 comprises an input interface 15, a first surface 11 and a second surface 12. The first surface 11 is opposite the second surface 12. The input interface 15 is disposed on the first surface 11. The cover 2 is configured to cover the first surface 11. The antenna bracket 3 is configured to cover the second surface 12.

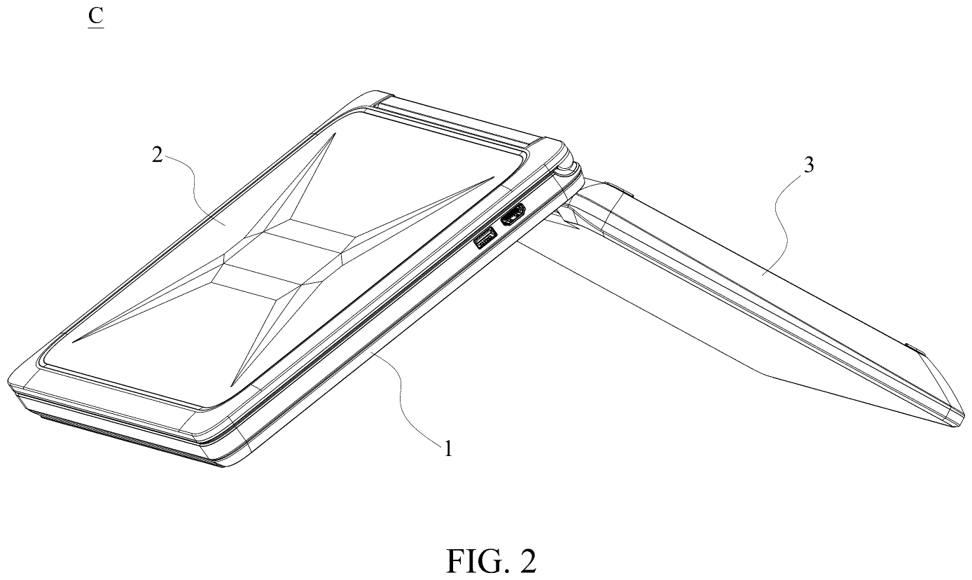

FIG. 2 shows the laptop computer of the embodiment of the invention, wherein the laptop computer is in a second spatial posture. With reference to FIGS. 1A, 2A and 2, in one embodiment, in a first spatial posture (FIGS. 1A and 1B), the antenna bracket 3 is in a first bracket position and overlaps the computer body 1. In the first spatial posture, the laptop computer C is configured to provide common laptop functions. In a second spatial posture (FIG. 2), the antenna bracket 3 is in a second bracket position and forms a V-shaped structure with the computer body 1 in a side projection plane. In the second spatial posture, the laptop computer C is configured to be independently used as a satellite signal station.

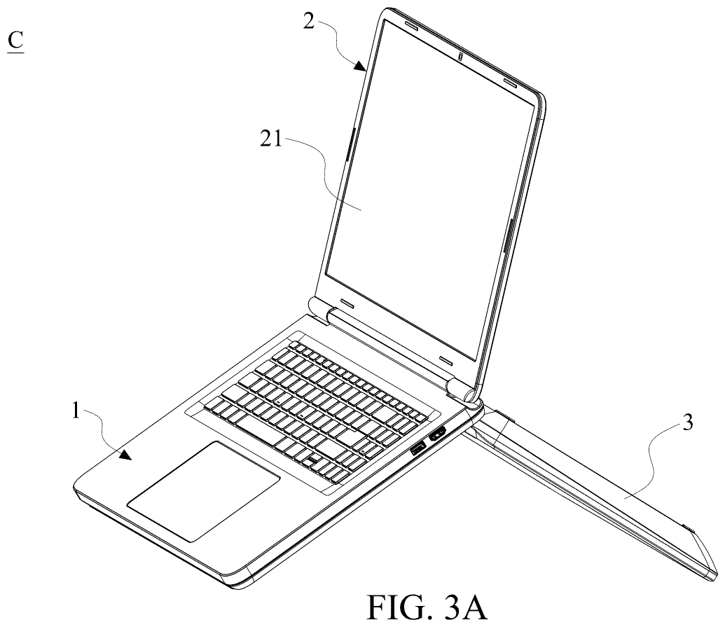

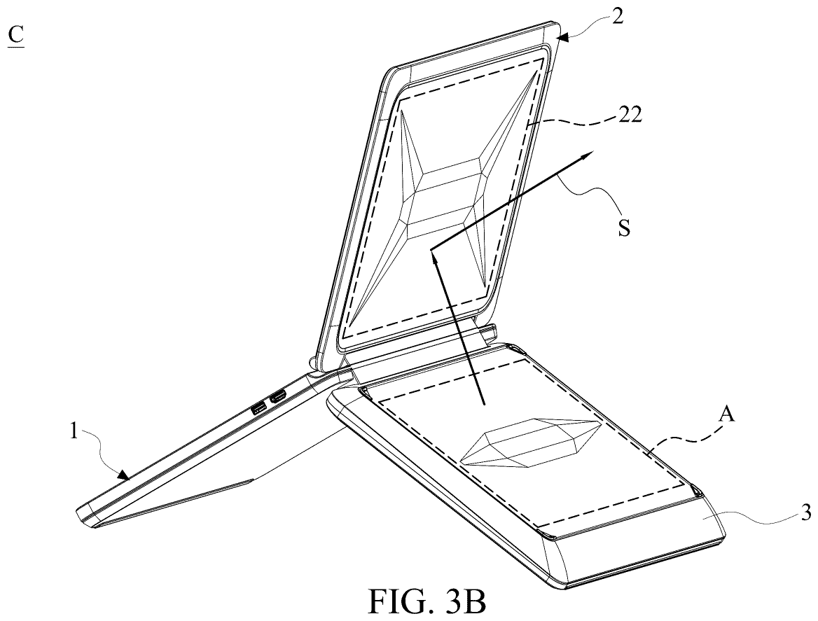

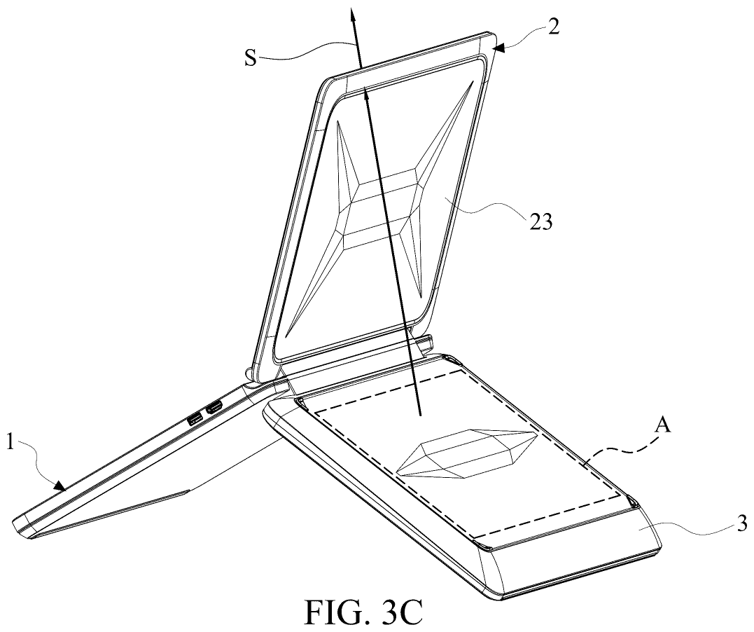

FIGS. 3A and 3B show the laptop computer of the embodiment of the invention, wherein the laptop computer is in a third spatial posture. With reference to FIGS. 3A and 3B, in one embodiment, the cover 2 comprises a screen 21 and a phase modulation module 22, and the phase modulation module 22 is opposite the screen 21. In the third spatial posture, the laptop computer C can be operated while simultaneously providing satellite communication functionality.

With reference to FIGS. 3A and 3B, in one embodiment, in a third spatial posture, the cover 2 is in an open position relative to the computer body 1, and the antenna bracket 3 is in the second bracket position. The phase modulation module 22 is configured to perform phase modulation on at least a portion of the wireless signal S. Accordingly, the communication quality of low-elevation satellites can be improved. In one embodiment, the phase modulation module 22 can include a reconfigurable intelligent surface (RIS).

FIG. 3C shows a laptop computer of a modified embodiment of the invention. With reference to FIG. 3C, in one embodiment, the cover 2 comprises a lid 23, and the screen is disposed on the lid 23. The lid 23 comprises a non-metallic material, and the wireless signal S is configured to pass through at least a portion of the cover 2 for transmission.

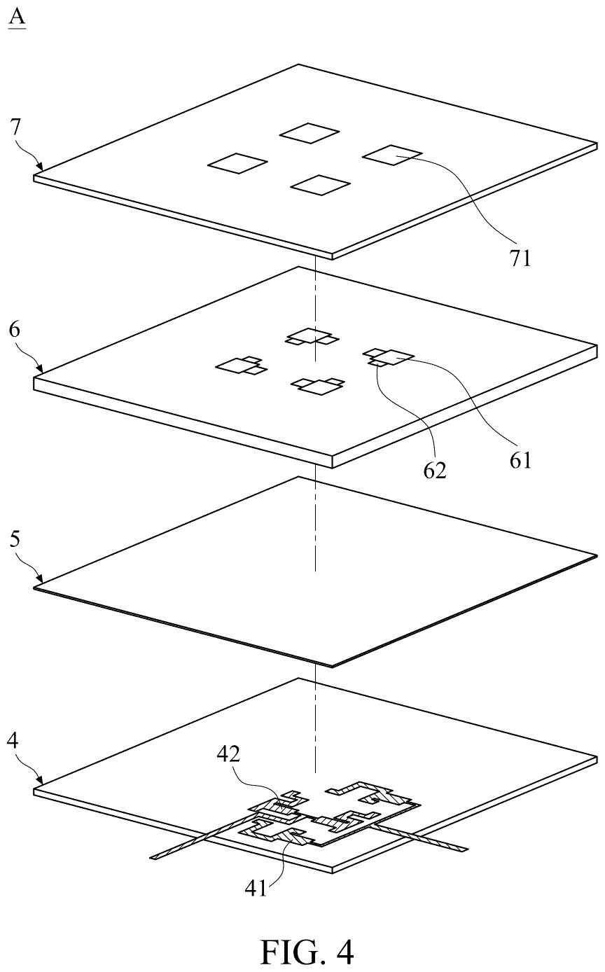

FIG. 4 is an exploded view of the antenna module of the embodiment of the invention. With reference to FIG. 4, in one embodiment, the antenna module A comprises a feeding unit 4, a ground layer 5, a first patch unit 6 and a second patch unit 7. The feeding unit 4 includes a horizontal feeding conductor 41 and a vertical feeding conductor 42. The ground layer 5 corresponds to the feeding unit 4. The first patch unit 6 corresponds to the feeding unit 4. The second patch unit 7 corresponds to the feeding unit 4 and the first patch unit 6, wherein the first patch unit 6 is located between the second patch unit 7 and the feeding unit 4. In one embodiment, the ground layer 5 is located between the feeding unit 4 and the first patch unit 6.

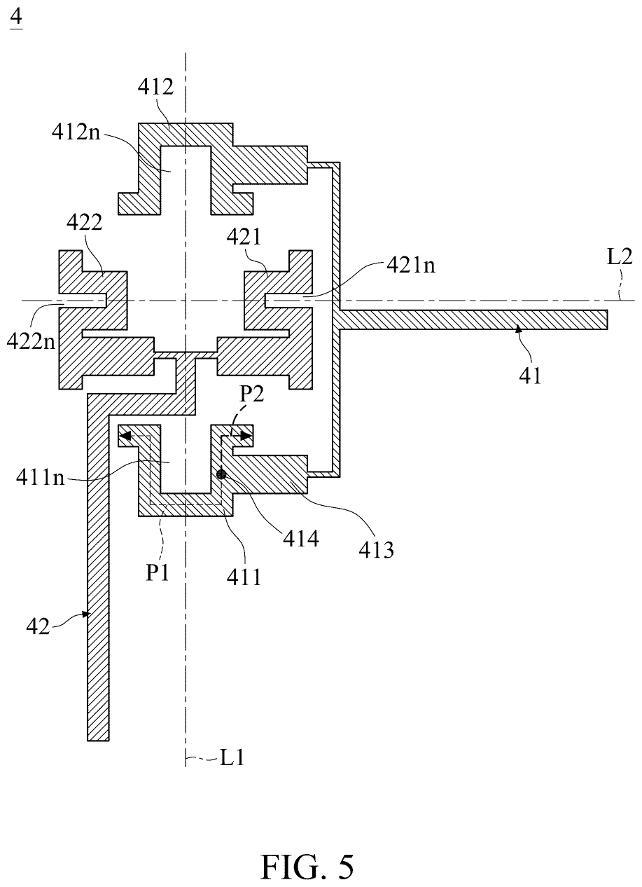

FIG. 5 shows the details of the feeding unit of the embodiment of the invention. With reference to FIG. 5, in one embodiment, the horizontal feeding conductor 41 comprises a first horizontal feeding structure 411 and a second horizontal feeding structure 412. The vertical feeding conductor 42 comprises a first vertical feeding structure 421 and a second vertical feeding structure 422. The first horizontal feeding structure 411 and the second horizontal feeding structure 412 are arranged along a vertical line L1. The first vertical feeding structure 421 and the second vertical feeding structure 422 are arranged along a horizontal line L2.

With reference to FIG. 5, in one embodiment, at least a portion of the vertical feeding conductor 42 is located between the first horizontal feeding structure 411 and the second horizontal feeding structure 412.

With reference to FIG. 5, in one embodiment, the first horizontal feeding structure 411 and the second horizontal feeding structure 412 are U-shaped. The first horizontal feeding structure 411 comprises a first notch 411n. The second horizontal feeding structure 412 comprises a second notch 412n. The first notch 411n faces the second notch 412n.

With reference to FIG. 5, in one embodiment, the first vertical feeding structure 421 and the second vertical feeding structure 422 are U-shaped. The first vertical feeding structure 421 comprises a third notch 421n. The second vertical feeding structure 422 comprises a fourth notch 422n. The third notch 421n is opposite the fourth notch 422n.

With reference to FIG. 5, in one embodiment, the horizontal feeding conductor 41 comprises an impedance matching structure 413. The impedance matching structure 413 is connected to a connection point 414 (the labeled in the figure is for position indication only) on the first horizontal feeding structure 411. A first surface current path P1 is defined between the connection point 414 and one end of the first horizontal feeding structure 411. A second surface current path P2 is defined between the connection point 414 and the other end of the first horizontal feeding structure 411. The length of the first surface current path P1 is not equal to the length of the second surface current path P2. In one embodiment, the phase difference between the first surface current path P1 and the second surface current path P2 can be 180 degrees, thereby creating out-of-phase feeding to achieve constructive interference.

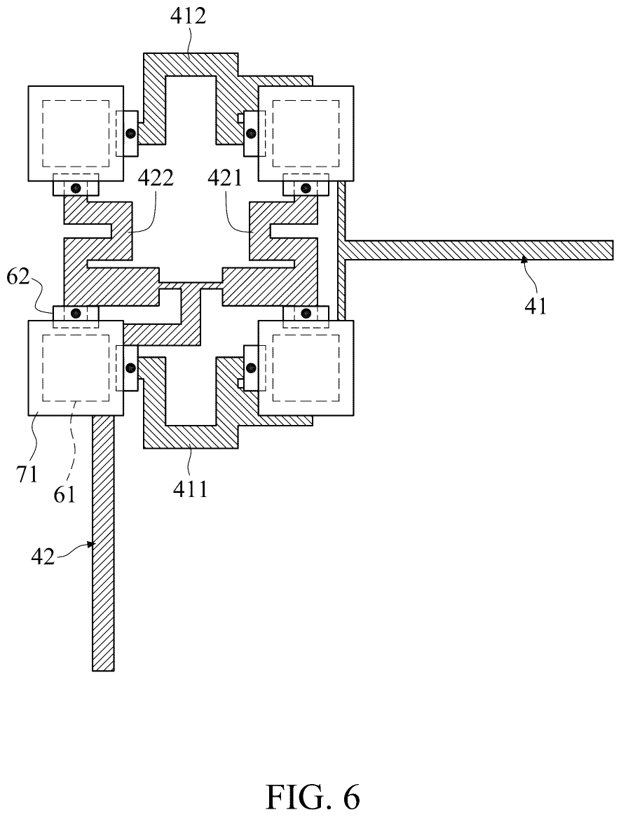

FIG. 6 is an assembled view of the antenna module of the embodiment of the invention. With reference to FIGS. 4, 5 and 6, in one embodiment, the first patch unit 6 comprises four first patches 61. The first horizontal feeding structure 411, the second horizontal feeding structure 412, the first vertical feeding structure 421, and the second vertical feeding structure 422 each feeds a respective feeding signal to a corresponding first patch 61.

With reference to FIGS. 4, 5 and 6, in one embodiment, the first patch unit 6 comprises a plurality of capacitive coupling pads 62. The capacitive coupling pads 62 are not in direct contact with the first patches 61. The capacitive coupling pads 62 are respectively coupled to the ends of the first horizontal feeding structure 411, the second horizontal feeding structure 412, the first vertical feeding structure 421 and the second vertical feeding structure 422. In this embodiment, the capacitive coupling pads 62 are coupled to the ends of the first horizontal feeding structure 411, the second horizontal feeding structure 412, the first vertical feeding structure 421 and the second vertical feeding structure 422 through via holes (represented by dots in the FIG. 6). In one embodiment, the inductance can be adjusted by varying the length of the via holes.

With reference to FIGS. 4, 5 and 6, in one embodiment, the second patch unit 7 comprises four second patches 71. The second patches 71 are larger in size than the first patches 61. The second patches 71 overlap the respective first patches 61. In one embodiment, the second patches 72 are electromagnetically coupled to the first patches 61 to excite multiple modes, thereby increasing the bandwidth of the antenna module.

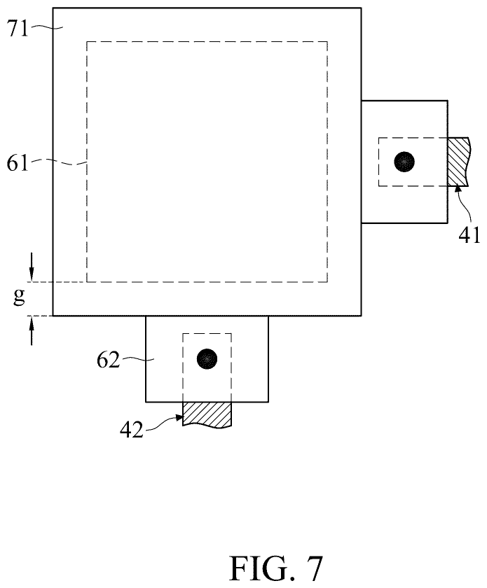

FIG. 7 shows the details of the capacitive coupling pad and the first patch of the embodiment of the invention. With reference to FIG. 7, in one embodiment, a gap g is formed between each capacitive coupling pad 62 and the adjacent first patch 61, and the second patch 71 covers the corresponding gaps g. In one embodiment, adjusting the gap g can modify the capacitance. By fine-tuning the aforementioned capacitance and inductance, the resonance effect and impedance matching of the antenna module can be improved.

In one embodiment, the antenna module of the embodiment of the invention meets the communication quality requirements of Tx Gain: 11 dBi and Rx Gain: 8 dBi. It is applicable to the Ku-band frequency range (Tx: 13.75 GHz~14.6 GHz; Rx: 11 GHz~12 GHz). The antenna polarization isolation satisfies (S21<−20 dB), approaching −30 dB. When the antenna module of the embodiment of the invention is applied to the aforementioned laptop computer, a 16×8=128 antenna module array can be utilized to achieve an Equivalent Isotropically Radiated Power (EIRP)>36 dBW.

In the laptop computer of the embodiment of the invention, the cover is rotatably connected to the computer body through the first hinge unit. The antenna bracket is rotatably connected to the computer body through the second hinge unit. The antenna module is disposed on the antenna bracket. Accordingly, the laptop computer can provide satellite communication functionality through the antenna module on the antenna bracket. Additionally, the orientation of the antenna bracket relative to the computer body can be adjusted to achieve optimal signal transmission. The laptop computer of the embodiment of the invention features a simple structure and is easy to carry, offering excellent convenience for users.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A laptop computer, comprising:
a computer body, comprising a first hinge unit and a second hinge unit;
a cover, rotatably connected to the computer body via the first hinge unit;
an antenna bracket, rotatably connected to the computer body via the second hinge unit; and
an antenna module, disposed on the antenna bracket and configured to transmit a wireless signal.

2. The laptop computer as claimed in claim 1, wherein the computer body comprises a body lateral side, the first hinge unit is disposed on the body lateral side, and the second hinge unit is also disposed on the body lateral side.

3. The laptop computer as claimed in claim 1, wherein the computer body comprises an input interface, a first surface and a second surface, the first surface is opposite the second surface, the input interface is disposed on the first surface, the cover is configured to cover the first surface, and the antenna bracket is configured to cover the second surface.

4. The laptop computer as claimed in claim 3, wherein, in a first spatial posture, the antenna bracket is in a first bracket position and overlaps the computer body, and in a second spatial posture, the antenna bracket is in a second bracket position and forms a V-shaped structure with the computer body in a side projection plane.

5. The laptop computer as claimed in claim 4, wherein the cover comprises a screen and a phase modulation module, and the phase modulation module is opposite the screen.

6. The laptop computer as claimed in claim 5, wherein, in a third spatial posture, the cover is in an open position relative to the computer body, the antenna bracket is in the second bracket position, and the phase modulation module is configured to perform phase modulation on at least a portion of the wireless signal.

7. The laptop computer as claimed in claim 4, wherein the cover comprises a screen and a lid, the screen is disposed on the lid, the lid comprises a non-metallic material, and the wireless signal is configured to pass through at least a portion of the cover for transmission.

8. The laptop computer as claimed in claim 1, wherein the antenna module comprises:
a feeding unit, comprising a horizontal feeding conductor and a vertical feeding conductor;
a ground layer, corresponding to the feeding unit;
a first patch unit, corresponding to the feeding unit; and
a second patch unit, corresponding to the feeding unit and the first patch unit, wherein the first patch unit is located between the second patch unit and the feeding unit.

9. The laptop computer as claimed in claim 8, wherein the horizontal feeding conductor comprises a first horizontal feeding structure and a second horizontal feeding structure, the vertical feeding conductor comprises a first vertical feeding structure and a second vertical feeding structure, the first horizontal feeding structure and the second horizontal feeding structure are arranged along a vertical line, and the first vertical feeding structure and the second vertical feeding structure are arranged along a horizontal line.

10. The laptop computer as claimed in claim 9, wherein at least a portion of the vertical feeding conductor is located between the first horizontal feeding structure and the second horizontal feeding structure.

11. The laptop computer as claimed in claim 10, wherein the first horizontal feeding structure and the second horizontal feeding structure are U-shaped, the first horizontal feeding structure comprises a first notch, the second horizontal feeding structure comprises a second notch, and the first notch faces the second notch.

12. The laptop computer as claimed in claim 11, wherein the first vertical feeding structure and the second vertical feeding structure are U-shaped, the first vertical feeding structure comprises a third notch, the second vertical feeding structure comprises a fourth notch, and the third notch is opposite the fourth notch.

13. The laptop computer as claimed in claim 11, wherein the horizontal feeding conductor comprises an impedance matching structure, the impedance matching structure is connected to a connection point on the first horizontal feeding structure, a first surface current path is defined between the connection point and one end of the first horizontal feeding structure, a second surface current path is defined between the connection point and the other end of the first horizontal feeding structure, and the length of the first surface current path is not equal to the length of the second surface current path.

14. The laptop computer as claimed in claim 10, wherein the first patch unit comprises four first patches, and the first horizontal feeding structure, the second horizontal feeding structure, the first vertical feeding structure and the second vertical feeding structure feed a plurality of feeding signals to the corresponding first patches.

15. The laptop computer as claimed in claim 14, wherein the first patch unit comprises a plurality of capacitive coupling pads, the capacitive coupling pads are not in direct contact with the first patches, and the capacitive coupling pads are respectively coupled to the ends of the first horizontal feeding structure, the second horizontal feeding structure, the first vertical feeding structure and the second vertical feeding structure.

16. The laptop computer as claimed in claim 15, wherein the second patch unit comprises four second patches, the second patches are larger in size than the first patches, and the second patches overlap the respective first patches.

17. The laptop computer as claimed in claim 16, wherein a gap is formed between each capacitive coupling pad and the adjacent first patch, and the second patch covers the corresponding gaps.

18. The laptop computer as claimed in claim 8, wherein the ground layer is located between the feeding unit and the first patch unit.
